(19) United States
(12) Patent Application Publication
(10) Pub. No.: US 2023/0313018 A1
(43) Pub. Date: Oct. 5, 2023

(54) MOF SINTERED BODY AND METHOD FOR PRODUCING THE SAME

(71) Applicant: HONDA MOTOR CO., LTD., Tokyo (JP)

(72) Inventors: Hideki MATSUDA, Saitama (JP); Mitsumasa SORAZAWA, Saitama (JP); Takayuki SAKATA, Saitama (JP); Shoji TAKAHASHI, Saitama (JP); Yushi FUJINAGA, Saitama (JP)

(21) Appl. No.: 18/190,140

(22) Filed: Mar. 27, 2023

(30) Foreign Application Priority Data
Mar. 31, 2022 (JP) 2022-061306

(51) Int. Cl. C09K 5/14; B01J 20/22; B01J 20/30; H01M 10/653

(52) U.S. Cl. CPC C09K 5/14; B01J 20/226; B01J 20/3078; H01M 10/653

(57) ABSTRACT

An object of the present invention is to sinter a MOF sufficiently firmly at a low temperature while ensuring the MOF sufficient adsorption performance. The present inventors have found that if a binder having a hydroxy group is mixed with a MOF having a terephthalic acid-based ligand, a sufficiently firm MOF can be obtained by sintering at a low temperature while ensuring sufficient adsorption performance, and thus the present invention has been completed. The MOF sintered body of the present invention contains a MOF having a terephthalic acid-based ligand and a binder having a hydroxy group OH. According to the present aspect, the sufficiently firm MOF can be obtained by sintering at a low temperature while ensuring sufficient adsorption performance.

This application is based on and claims the benefit of priority from Japanese Patent Application 2022-061306, filed on 31 Mar. 2022, the content of which is incorporated herein by reference.

### BACKGROUND OF THE INVENTION

### Field of the Invention

The present invention relates to a metal-organic framework (MOF) sintered body produced by sintering a MOF.

Related Art

In recent years, electric-powered vehicles, such as electric vehicles (EVs) and hybrid electric vehicle (HEVs), have become popular from the viewpoint of reducing carbon dioxide emissions and thus reducing adverse effects on the global environment. Electric-powered vehicles are equipped with batteries such as lithium-ion batteries.

### PATENT DOCUMENT 1: JAPANESE UNEXAMINED PATENT

Application, Publication No. 2017-72326

### SUMMARY OF THE INVENTION

In general, excessively high temperatures cause batteries to discharge and degrade faster. On the other hand, excessively low temperatures cause batteries to lose their ability to output sufficient voltage. Therefore, it is important to control the temperature of batteries.

The present inventors have conceived of the idea of using MOFs to control the temperature of batteries. That is, for example, when a battery has a high temperature, an adsorbate such as water or carbon dioxide adsorbed on a MOF is desorbed from the MOF by heat of the battery to thereby store latent heat in the MOF and cool the battery by heat absorption during this process. Also, for example, when the battery has a low temperature, an adsorbate such as water or carbon dioxide is adsorbed on the MOF to thereby release latent heat from the MOF and warm the battery by heat generation during this process.

The MOF has excellent adsorption performance for water, carbon dioxide, etc., but scatters when in a powder form. Therefore, it is necessary to add a binder, etc. to the MOF and sinter the resultant mixture into a bulk body. However, the MOF has low heat resistance, so is required to be sintered at a low temperature. In addition, the binder should not interfere with the adsorption performance of the MOF, in other words, sufficiently high adsorption performance of the MOF should be ensured.

The present invention is made in view of circumstances as mentioned above, and an object thereof is to sinter a MOF sufficiently firmly at a low temperature while ensuring the MOF sufficient adsorption performance.

The present inventors have found that if a binder having a hydroxy group is mixed with a MOF having a terephthalic acid-based ligand, a MOF can be sintered sufficiently firmly at a low temperature while ensuring the MOF sufficient adsorption performance, and thus the present invention has been completed. The present invention is directed to a MOF sintered body according to any one of aspects (1) to (3) below and a MOF sintered body production method according to aspect (4) below.
(1) A MOF sintered body including: a MOF having a terephthalic acid-based ligand; and a binder having a hydroxy group.

According to this aspect, as mentioned above, the MOF can be sintered sufficiently firmly at a low temperature while ensuring the MOF sufficient adsorption performance.
(2) The MOF sintered body according to aspect (1), in which the binder is silica, and the silica is contained in an amount of 2 to 8% by weight of the MOF.

Containing the silica in an amount of 2% by weight or more allows the MOF to be sintered into a firmer product. Furthermore, containing the silica in an amount of 8% by weight or less can prevent a decrease in a heat storage density of the MOF sintered body due to excessive silica.
(3) The MOF sintered body according to aspects (1) or (2), in which the MOF sintered body is installed in a moving body and is configured to exchange heat with a battery that supplies electric power to a driver that moves the moving body.

According to this aspect, the temperature of the battery installed in the moving body can be controlled using the MOF sintered body.
(4) A method for producing a MOF sintered body, the method including: producing a slurry that includes a MOF having a terephthalic acid-based ligand and a binder having a hydroxy group; and heating the slurry at 120° C. or less to thereby sinter the MOF.

According to this aspect, by heating at the slurry at 120° C. or less, the MOF sintered body according to aspect (1) can be produced without damaging the MOF which has low heat resistance.

As mentioned above, according to aspect (1), the MOF can be sintered sufficiently firmly at a low temperature while ensuring the MOF sufficient adsorption performance. Furthermore, according to any one of aspects (2) to (4), respective additional effects can be achieved.

### BRIEF DESCRIPTION OF THE DRAWINGS

FIG. 1 is a schematic diagram showing a MOF sintered body according to the present embodiment;

FIG. 2 is a conceptual drawing of a MOF upon heat storage;

FIG. 3 is a conceptual drawing of a MOF upon heat release;

FIG. 4 is a flow chart showing a method for producing a MOF sintered body;

FIG. 5 is a conceptual drawing of a MOF sintered body having silica as a binder;

FIG. 6 is a conceptual drawing of a MOF sintered body having a silicon sealant as a binder;

FIG. 7 is a conceptual drawing of a MOF sintered body having p-alumina as a binder;

FIG. 8 is a graph showing an adsorbed amount for each of MOF sintered bodies having different binders;

FIG. 9 is a graph showing bending strength for each of MOF sintered bodies having different binders; and

FIG. 10 is a graph showing a relationship between an added amount of silica sol and bending stress.

### DETAILED DESCRIPTION OF THE INVENTION

Hereinafter, embodiments of the present invention will be described with reference to drawings. However, the present invention is not limited to the embodiments, and modifications can be appropriately made without deviating from the scope of the present invention.

### First Embodiment

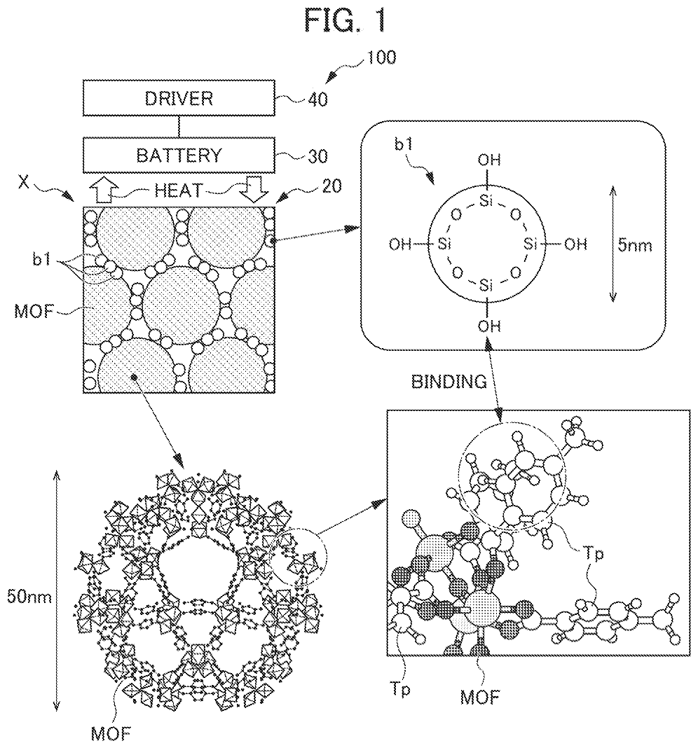

FIG. 1 is a schematic diagram showing a heat storage system 20 according to the present embodiment. The heat storage system 20 is installed in an electric-powered vehicle 100 such as an EV, an HEV, etc. The electric-powered vehicle 100 is equipped with a driver 40, such as a motor, configured to move the electric-powered vehicle 100 and a battery 30 configured to supply electric power to the driver 40. The battery 30 is, for example, a lithium-ion battery including a liquid electrolyte.

The heat storage system 20 is installed for the battery 30 and configured to cool and warm the battery 30 by heat exchange with the battery 30. The heat storage system 20 includes a MOF sintered body X and an adsorbate Ad to be adsorbed on the MOF sintered body X. The adsorbate Ad may be, for example, water, ethanol, or carbon dioxide.

The MOF sintered body X includes a metal-organic framework (MOF) as a main component and a silica b1 as a binder. The MOF is MIL 101 and has a pore structure and a terephthalic acid-based ligand Tp. The MOF has a particle diameter of about 50 nm and the silica b1 has a particle diameter of about 5 nm. In other words, the MOF has a particle diameter about ten times larger than the silica b1. The silica b1 has a hydroxy group OH. The MOFs bind to each other via the silica b1 by binding the hydroxy group OH in the silica b1 to the terephthalic acid-based ligand Tp in the MOF.

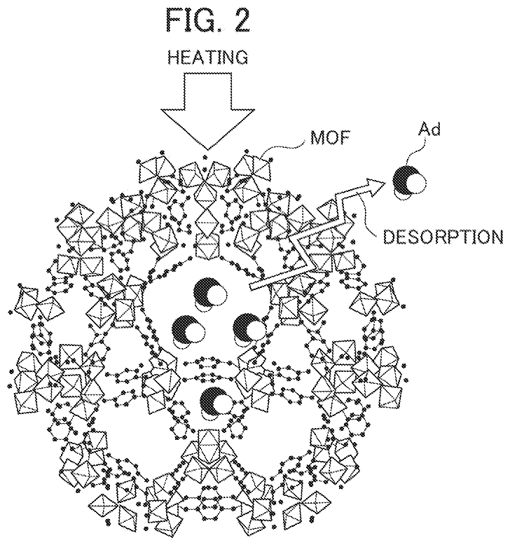

FIG. 2 is a conceptual drawing of the MOF upon heat storage during which latent heat is stored in the MOF. The adsorbate Ad adsorbed on the MOF having the pore structure is desorbed from the MOF by absorbing heat of the battery 30. This allows latent heat to be stored in the MOF and the battery 30 is cooled by heat absorption during this process.

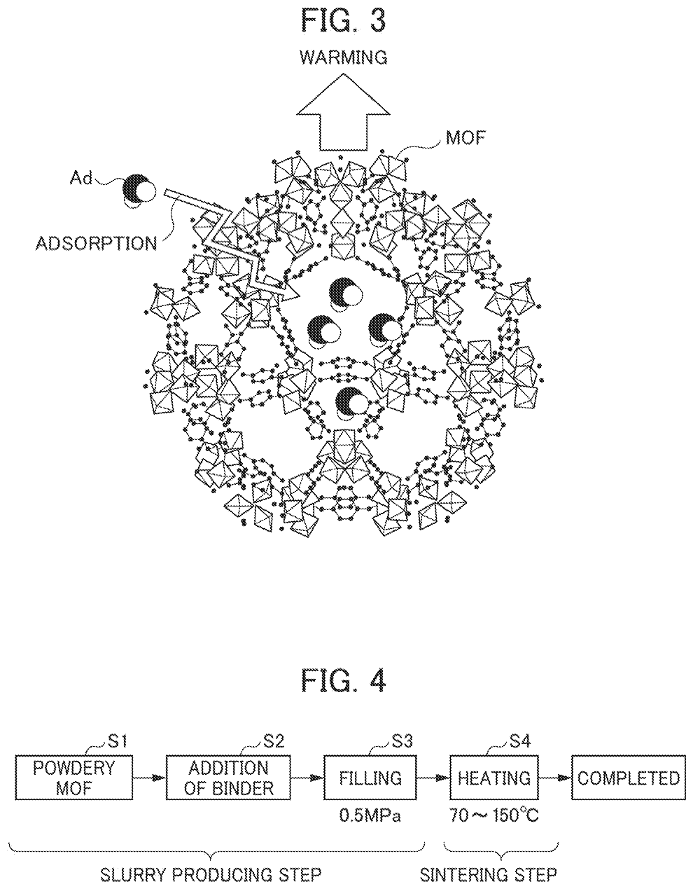

FIG. 3 is a conceptual drawing of the MOF upon heat release during which latent heat is released from the MOF. The adsorbate Ad is adsorbed on the MOF having the pore structure. This allows latent heat to be released from the MOF and the battery 30 is warmed by heat generation during this process.

FIG. 4 is a flow chart showing a method for producing a MOF sintered body X. First, in S1, a powdery MOF is prepared. Next, in S2, silica sol as a binder liquid containing 20% by weight of silicon dioxide is added to the powdery MOF in an amount of 10 to 40% by weight relative to the MOF. This means that the silica b1 is added to the powdery MOF in an amount of 2 to 8% by weight relative to the MOF. This results in a slurry containing the MOF and the silica b1. Next, in S3, a mold is filled with the slurry and the slurry is molded with a pressure of about 0.5 MPa. The S1 to S3 above corresponds to a slurry producing step.

Next, in S4, the thus-molded slurry is heated at 75 to 150° C. to thereby produce a MOF sintered body X. The slurry is preferably heated at a temperature of 120° C. or less due to the low heat resistance of the MOF. This heating completes the MOF sintered body X. The S4 corresponds to a sintering step. The MOF sintered body X is, for example, a bulk body that is an approximately 5 mm by 5 mm square in a plan view and has a thickness of about 1 mm. The silica is contained in the MOF sintered body X in an amount of 2 to 8% by weight relative to the MOF, as mentioned above.

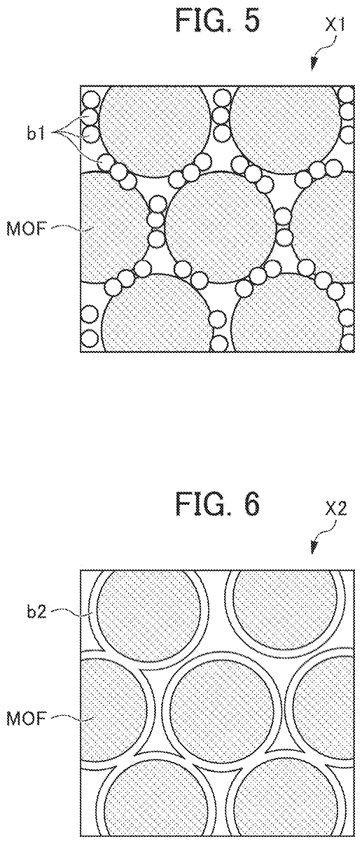

Next, with reference to FIGS. 5 to 9, the reason why the silica b1 is employed as a binder will be explained.

FIG. 5 is a conceptual drawing of a MOF sintered body X1 having the same binder as in the MOF sintered body X according to the present embodiment, that is, having the silica b1 as a binder. Specifically, the MOF sintered body X1 is produced by adding the silica sol having the above-mentioned concentration to the MOF in an amount of 40% by weight relative to the MOF to thereby form a slurry, molding the slurry, and sintering the slurry via heating at 120° C. for about 1 hour. As mentioned above, the silica b1 has a particle diameter of 5 nm which is about one-tenth the particle diameter of the MOF.

FIG. 6 is a conceptual drawing of a MOF sintered body X2 having a silicon sealant b2 as a binder. Specifically, the MOF sintered body X2 is produced by adding silicon paste to the MOF in an amount of 40% by weight relative to the MOF to thereby form a slurry, molding the slurry, and sintering the slurry via heating at 150° C. for about 30 minutes. The silicon sealant b2 has a particle diameter of a molecular scale, in particular, about 5 Å which is about one-hundredth the particle diameter of the MOF.

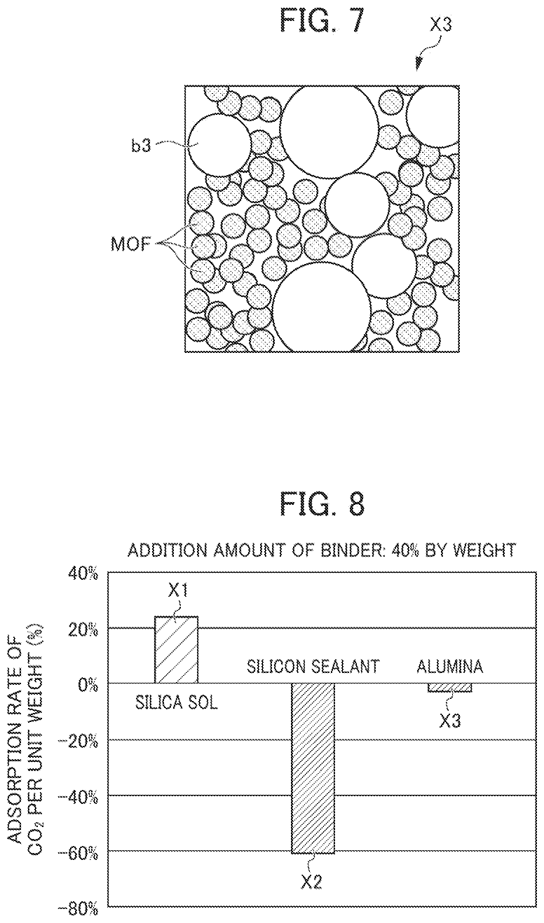

FIG. 7 is a conceptual drawing of a MOF sintered body X3 having p-alumina b3 as a binder. Specifically, the MOF sintered body X3 is produced by adding powdery p-alumina b3 to the MOF in an amount of 40% by weight relative to the MOF to thereby form a slurry, molding the slurry, and sintering the slurry via heating at 110° C. for about 1 hour. The p-alumina b3 has a particle diameter of about 10 μm which is about two-hundred times larger than the particle diameter of the MOF.

FIG. 8 is a graph showing an adsorbed amount of CO2 per unit weight for each of the MOF sintered bodies X1 to X3 as described above. The longitudinal axis shows a change in the adsorbed amount of CO₂ as compared to one without the binder. In the case of the MOF sintered body X2 having the silicon sealant b2 as the binder, the adsorbed amount of CO₂ was significantly decreased as compared to one without the binder. Furthermore, in the case of the MOF sintered body X3 having the ρ-alumina b3 as the binder, the adsorbed amount of CO₂ was slightly decreased as compared to one without the binder. These results suggest that the silicon sealant b2 and the ρ-alumina b3 inhibited adsorption performance of the MOF.

On the other hand, in the case of the MOF sintered body X1 having the silica b1 as the binder, the adsorbed amount of CO₂ was conversely increased as compared to one without the binder. This result suggests that the silica b1 is the most preferred binder among the three binders b1 to b3 in terms of adsorptivity.

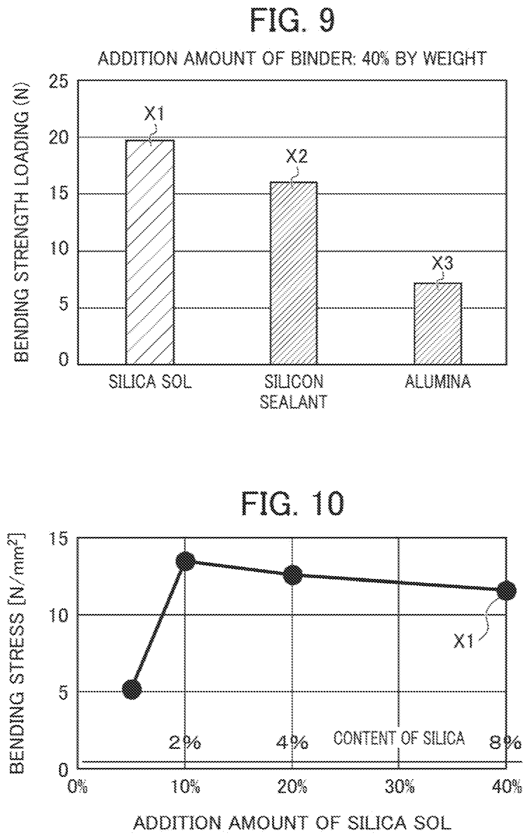

FIG. 9 is a graph showing bending strength for each of the MOF sintered bodies X1 to X3. It was confirmed that the MOF sintered body X1 having the silica b1 as the binder had higher bending strength than both the MOF sintered body X2 having the silicon sealant b2 as the binder and the MOF sintered body X3 having the 92 -alumina b3 as the binder. This result suggests that the silica b1 is the most preferred binder among the three binders also in terms of strength. Note that, it is considered that such high bending strength is due to tight binding between the terephthalic acid-based ligand Tp in the MOF and the hydroxy group OH in the silica b1, as mentioned above.

Thus, the silica b1 was confirmed to be the most preferred binder in terms of the adsorptivity and the bending strength. Therefore, in the present embodiment, the silica b1 is employed as the binder as mentioned above.

Next, with reference to FIG. 10, the reason why the silica b1 is contained in an amount of 2 to 8% by weight relative to the MOF will be explained.

FIG. 10 is a graph showing a relationship between an amount of silica sol added to the MOF and bending stress of the MOF sintered body. Note that, each of the MOF sintered bodies was also sintered at a temperature of 120° C. This graph revealed that the bending stress reached a maximum when the silica sol was added in an amount of about 10% by weight relative to the MOF and then the bending stress gradually decreased as the amount of silica sol increased. However, the bending strength of the MOF sintered body when the silica sol was added in an amount of 40% by weight relative to the MOF is not significantly different from when the silica sol was added in an amount of about 10% by weight. These results revealed that the silica sol was preferably added in an amount of 10% by weight or more, that is, the silica b1 is contained in the MOF sintered body in an amount of 2% by weight or more relative to the MOF.

Note that, an upper limit of an amount of the silica b1 contained in the MOF sintered body is not particularly limited, but is preferably 8% by weight or less, more preferably 6% by weight or less, and further preferably 4% by weight or less relative to the MOF so as not to contain a wasteful excess of the silica b1.

Thus, in the present embodiment, as mentioned above, the silica b1 is contained in the MOF sintered body in an amount of 2 to 8% by weight relative to the MOF.

Constitutions and effects of the present embodiment will be summarized below.

When the silica b1 which is a binder having a hydroxy group OH was added to MIL 101 which is a MOF having a terephthalic acid-based ligand Tp, it was confirmed that adsorption performance of the MOF could be sufficiently ensured as shown in FIG. 8 and the MOF could be sintered sufficiently firmly even at a low temperature of 120° C. as shown in FIG. 9. Therefore, according to the MOF sintered body X of the present embodiment containing the MIL101 and the silica b1, the MOF could be sintered sufficiently firmly even at a low temperature, while ensuring the MOF sufficient adsorption performance.

As shown in FIG. 10, it was also confirmed that the MOF could be more firmly sintered by including the silica b1 in the MOF sintered body X in an amount of 2% by weight or more relative to the MOF. Therefore, the MOF sintered body X according to the present embodiment containing 2% by weight or more of the silica b1 allows the MOF to be more firmly sintered. In addition, since the silica b1 is contained in an amount of 8% by weight or less, a decrease in a heat storage density of the MOF sintered body due to excessive silica b1 can be prevented.

The heat storage system 20 including the MOF sintered body X is installed in the electric-powered vehicle 100 and configured to exchange heat with the battery 30 supplying electric power to the driver 40 in the electric-powered vehicle 100. Therefore, a temperature of the battery 30 installed in the electric-powered vehicle 100 can be controlled using the MOF sintered body X.

In the sintering step S4, as mentioned above, the slurry is preferably heated at 120° C. or less. In fact, the MOF sintered body X can be produced without damaging the MOF having low heat resistance by heating at 120° C. or less.

### Modified Embodiment

The above-mentioned embodiment can be, for example, modified as mentioned below. As mentioned above, the above embodiment is considered to exert its effects by a combination of the terephthalic acid-based ligand Tp with the hydroxy group OH. Therefore, the MOF may be changed to a MOF having a terephthalic acid-based ligand other than the MIL 101. The binder can also be changed to a binder having a hydroxy group other than the silica.

For example, when sufficient bending strength can be achieved even at an amount of the silica b1 of less than 2% by weight in the MOF sintered body X, the silica b1 may be contained in an amount of less than 2% by weight relative to the MOF.

The battery 30 and the heat storage system 20 may be installed in a moving body other than the electric-powered vehicle 100, for example, a ship, a drone, etc., or in a fixed body. The heat storage system 20 may be installed in those other than the battery 30, for example, various circuits that generate a large amount of heat.

### EXPLANATION OF REFERENCE NUMERALS

20 Heat storage system
30 Battery
40 Driver
100 Electric-powered vehicle as moving body
b1 Silica as binder having hydroxy group
S1 Substep of slurry producing step
S2 Substep of slurry producing step
S3 Substep of slurry producing step
S4 Sintering step

What is claimed is:

1. A MOF sintered body comprising:
a MOF having a terephthalic acid-based ligand; and
a binder having a hydroxy group.

2. The MOF sintered body according to claim 1, wherein the binder is silica, and
the silica is contained in an amount of 2 to 8% by weight of the MOF.

3. The MOF sintered body according to claim 1, wherein the MOF sintered body is installed in a moving body and
is configured to exchange heat with a battery that supplies electric power to a driver that moves the moving body.

4. A method for producing a MOF sintered body, the method comprising:
producing a slurry that comprises a MOF having a terephthalic acid-based ligand and a binder having a hydroxy group; and
heating the slurry at 120° C. or less to thereby produce a MOF sintered body.
